(19) United States
(12) Patent Application Publication
(10) Pub. No.: US 2024/0258822 A1
(43) Pub. Date: Aug. 1, 2024

(54) Stationary Dual Hand And Foot Pedal Energy Harnessing Exercise Machine

(71) Applicant: Brock Tyler Horstman, Salem, OH (US)

(72) Inventor: Brock Tyler Horstman, Salem, OH (US)

(21) Appl. No.: 18/162,128

(22) Filed: Jan. 31, 2023

(51) Int. Cl. H02J 7/14; A63B 22/00; A63B 22/06

(52) U.S. Cl. CPC H02J 7/1407; A63B 22/001; A63B 22/0605

(57) ABSTRACT

A stationary dual hand and foot pedal energy-harnessing exercise bike with flywheels helping to turn over alternators bracketed and anchored about the exercise machinery which subsequently connects from the terminals by wiring and charge shelved batteries in battery banks with conversion by power converters to turn electricity into standardized power levels such as 110-Volt A/C and other standard outlet energy source levels with use of battery bank compartment external plug-in panel outlets.

### BACKGROUND—TECHNICAL FIELD

The present invention relates to exercise bike machinery, automotive style alternators, and electrical engineering.

### BACKGROUND—PRIOR ART

The following is a tabulation of some prior art that presently appears relevant:

### NON-PATENT LITERATURE DOCUMENTS

Silver, Andrew. “Are Stationary Bikes That Generate Electricity Making a Comeback 48” IEEE Spectrum, IEEE Spectrum, 24 Jun. 2021, https://spectrum.ieee.org/bikes-that-generate-electricity-are-making-a-comeback.

James, S. (2022) Can I buy an electricity generating bike 48, Energy. Energy. Available at: https://energym.io/blogs/news/can-i-buy-an-electricity-generating-bike (Accessed: Jan. 24, 2023).

Energy harnessing from the turnover of a bike has been accomplished prior to now by devices known as bike generator dynamos. The problem with this technology is that it has minimal energy storage capacity and minimal energy transferal capacity, only charging with the capacity to charge a single cell phone or laptop at a time, which renders prior art largely obsolete based on limited energy storage parameters.

Energy harnessing bikes have been produced in a gym in San Francisco; however, the machines don't harness many of the potential advantages that such machinery can be made to do—for example, it lacks direct outlets on the machine. This makes it obsolete as a solo power station. Prior art also lacks the connected foot and hand pedal design for increased human torque transferal to the rotor, similar in function to a wind resistance exercise bike's design without the wind resistance fan blades. This improvement would afford prior art with increased torque and therefore greater energy generating capacity. Simultaneously pedaling from hand and foot pedals that are connected reduces a previously unnoticed limit to energy production maximization potential of exercise bike machinery from the force produced by a human propelling it by utilizing only leg pedals for pedaling up until now. This is a limitation of all prior art. Many of the potential advantages of owning a stationary dual hand and foot pedal energy harnessing bike comes from owning one as a homeowner or business owner rather than one made specifically for a gym setting. In any home based applications where only one or two machines would be needed to power an entire facility, home, or to supplement the energy requirements of either.

Independent energy harnessing exercise machinery for in-home use has not been optimized for highest power production capacity. They do not include dual hand and foot pedals, they do not incorporate large diameter flywheels for inertia maintenance (making power production smoother, easier, and more efficient for the peddler of the bike,) they do not attach one or more alternators for replacement for increased power capacity, and they do not supply a power station compartment for housing batteries, plugging in cords directly to a power station, child-proofing the hazardous components, nor for converting the energy into higher available voltages like household and industrial 110-volt and 220-volt alternating currents.

Until now, no exercise machines have been created with alternators attached to produce energy that is made for transmission to any type of one or more batteries shelved in a sealable, child-proof, lidded electrical compartment that converts said energy from DC batteries through a power converter to usable household electrical currents of 110-Volt Alternating Current and 220-Volt Alternating Current in standard plug-in forms on the external paneling walls. These advantages over prior arts allow for significantly higher energy production capacity along with significantly increased energy production efficiency and ease of use are what make up for said prior shortcomings as follows.

### SUMMARY

In accordance with one embodiment a stationary dual hand and foot pedal exercise bike that turns over one or more flywheels and one more alternators that charge one or more batteries that are shelved within one or more battery housing compartments whereby built-in power converter(s) transmit energy in said battery housing compartment(s) from the battery(s) that supply said power converter with Battery-Based Direct Currents which convert the voltages stored in said battery(s) to standardized voltage ranges such as 110 and 220-Volt Alternating Current that supply the power cords which supply the external wall's housing compartment box with a panel supplying one or more standardized voltage settings for external plug ins, such as 110-Volt Alternating Current outlets and 220-Volt Alternating Current outlets as current examples.

### Advantages

Accordingly several advantages exist with the use of a stationary hand and foot pedal energy-harnessing exercise bike. Embodiment reduces requirement of other external sources of energy and therefore subrogates those energy costs. Embodiment replaces external energy sources as a sole, primary or supplemental energy production source. Embodiment reduces a person's carbon footprint through using cleaner energy with embodiment compared to reliance on external energy sources. Embodiment creates a power station where there otherwise was none. Embodiment ensures a purchaser shall have energy when other power sources fail. Embodiment generates A/C power that, when plugged into a household electrical system, redistributes surplus electrical supply added to household electrical wattage in reverse direction back through the standardized energy grid. In doing this, embodiment makes one's own electrical home connection a makeshift energy production facility for the energy grid that the user would otherwise only be a consumer on. This advantage allows the user to earn compensation for home energy production surpluses through contribution back to the regulated energy grid required by law to pay for energy received in the same way that by law the energy grid companies are required to be paid for electricity transferred.

### DRAWINGS—FIGURES

FIG. 1 shows entire embodiment with battery housing compartment outlet panel hood unlatched and opened

FIG. 2 shows hand and foot pedal exercise bike

FIG. 3 shows flywheel connected to belt connecting one or more alternators fixed with brackets connected by wiring to battery housing compartment battery bank

FIG. 4 shows battery housing compartment with visible power converter affixed to interior wall with battery compartment outlet panel hood unlatched and opened FIG. 5 shows a childproof alternator cover as it attaches to the battery housing compartment.

FIG. 6 shows the battery housing compartment brackets in detail which connect to and fix the alternators in place.

Drawings- Reference Numerals

| | |
|---|---|
| 1. Seat | 2. Foot Pedal |
| 3. Hand Pedal | 4. Rotor Shaft |
| 5. Exercise Bike Belt | 6. Flywheel |
| 7. Flywheel-Alternator Belt | 8. Alternator |
| 9. Alternator Bracket | 10. Alternator-Battery Wiring |
| 11. Battery Shelf | 12. Power Converter |
| 13. Power Converter-battery Wiring | 14. Battery Housing Compartment |
| 15. Battery Housing Compartment Outlet Panel | 16. 110-Volt Alternating Current Outlet |
| 17. 220-Volt Alternating Current Outlet | 18. Battery Housing Compartment Hood |
| 19. Battery Housing Compartment Latch | 20. Battery Housing Compartment Bracket |
| 21. Childproof Generator housing bolt holes | 22. Childproof Generator Housing |
| 23. Childproof Generator Housing Heat Vent | 24. Childproof Generator Housing Flywheel Cage |
| 25. Risk of Electric Shock Warning Label | 26. Childproof Generator Housing Rubber Flaps |
| 27. Rubber Flap Latch Hook | 28. Bracket Arms for Generator Attachment |
| 29. Angle Iron To Bracket Arms | 30. Alternator Generators |

### DETAILED DESCRIPTION

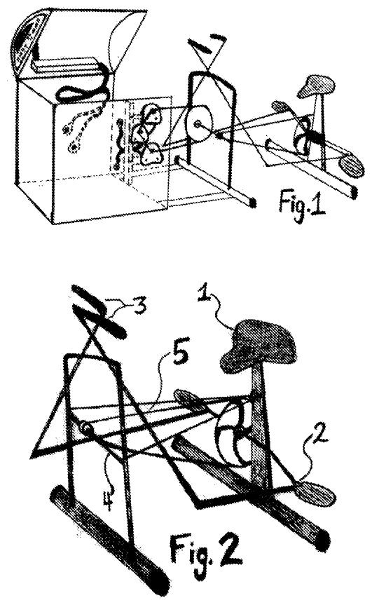

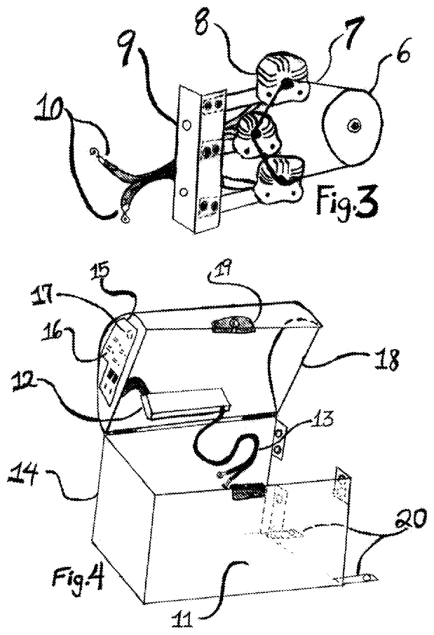

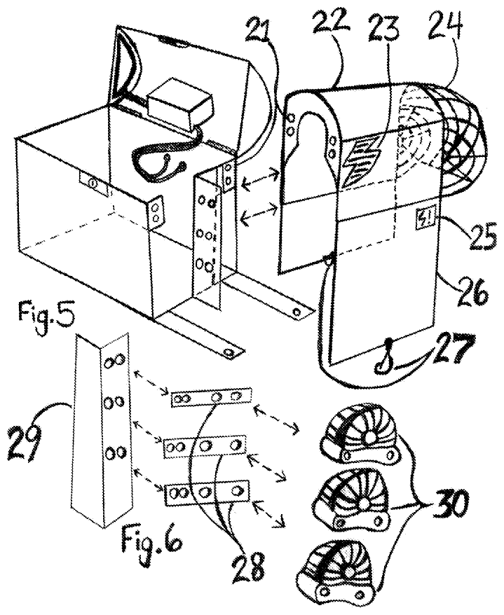

Embodiment is a stationary hand and foot pedal exercise bike frame shown in FIG. 1 and FIG. 2 with hand pedals attached to the foot pedals for increased torque during bike pedaling. Said embodiment has a flywheel instead of wind resistance fan blades on the rotor to supply the belt with leveraged inertia that turns 1 or more alternators for various levels of energy production. These alternators are fixed in place with bracketing as shown in FIG. 3 and FIG. 6 and wired for attachment to charge one or more batteries in one or more battery shelving compartments as shown in FIG. 4 and FIG. 5. Cords that connect the one or more power converters to the batteries are fixed to the internal walls of the housing compartments for converting DC energy to 110-Volt or 220-Volt Alternating Current with one or more outlets to supply 110 and 220 Volt levels with corresponding power outlets installed into battery compartment's external wall paneling for external plug in panel use.

### Operation

Embodiment can be propelled by a human who pedals the hand and foot pedals on the bike to turn over the rotor shaft on the bike. This turns over the connected flywheel which helps to turnover the connected alternator(s) attached by belt to the flywheel(s) that then rotate their coils which produce electrical currents levels harvestable. Electrical wires attached to the terminals of each alternator combine onto wiring for attachment to one or more Direct Current batteries in the battery shelving compartment (FIG. 4, Reference Numeral 11). When the battery(s) are charged by the bike, it then sends the electrical charge through electrical wires to be converted by the power converter from Battery Bank DC energy to 110-Volt and 220-Volt AC household standard plug-in energy. A light on the battery housing compartment outlet panel (FIG. 4, Ref. Number 15) will turn on when energy is available from the charged battery(s). When the attached batteries are adequately charged, it will supply 110-Volt and 220-Volt AC energy to one or more power cords at a time.

### Advantages

This type of energetic production allows each owner of said embodiment to be able to produce their own energy with exercise that is free from the limitations and expenses of other sources of energy while still being a renewable, reliable, and eco-friendly source of power. Said embodiment will liberate any owner of power dependency from other forms of electricity which limit consumers based on fixed energetic costs from sources like the electrical grid or natural gas. Said embodiment will also liberate consumers of otherwise unreliable, unsubstantial, or cost-ineffective sources of energy like solar and wind energy.

### Conclusion, Ramifications, and Scope

The reader will see that any embodiment of the stationary dual hand and foot pedal energy harnessing exercise bike creates a new way for people of any age to have a no-impact exercise machine that harnesses their own kinetic energy to be stored and used independently of other energy sources in a more efficient manner than prior art.

While above description contains many potential applications for usage, these should not be construed as a limitation on the scope, but rather as an exemplification of one of several of its embodiments. Many other variations are possible. For example, the stationary dual hand and foot energy harnessing exercise bike may be used as a way to keep athletes warm between bouts of exercise, or as a way to stay in shape like other exercise bikes without regards, or in addition to, the embodiments' energy production capabilities.

Accordingly, the scope of the disclosure should be determined not by the embodiment(s) illustrated, but by the appended claims and their legal equivalents.

I claim:

1. A stationary, dual hand and foot pedal driving energy harnessing exercise machine.

2. A stationary dual hand and foot pedal driving exercise bike with one or more flywheels and one or More gearing systems turning over one or more alternators for energy current production.

3. A system of one or more alternators connected and propelled by belt and turned over by human exercise propulsion connected by terminal wires to charge one or more batteries in one or more housing compartments for storage and use.

4. One more batteries in one or more battery bank housing compartments with power converters for external compartment wall plug-in panel usage of battery power.
